(19) United States
(12) Patent Application Publication
(10) Pub. No.: US 2007/0168210 A1
(43) Pub. Date: Jul. 19, 2007

(54) System and Method for Attracting Private Investment in a Cooperative

(76) Inventor: Patrick Grant, Charleston, IL (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/620,270

(22) Filed: Jan. 5, 2007

Related U.S. Application Data
(60) Provisional application No. 60/758,470, filed on Jan. 12, 2006.

(51) Int. Cl. G06Q 99/00

(52) U.S. Cl. 705/1

(57) ABSTRACT

The present invention relates to an improved system and method for forming a cooperative. In one embodiment, the system and method relates to forming both a corporation entity and a cooperative entity and selling some ownership percentage of the corporation to the cooperative. In a further embodiment, the system and method further provides for a marketing process that incentivizes entities to join the cooperative.

### CROSS-REFERENCE TO RELATED APPLICATION(S)

The present application claims priority to U.S. Provisional Application 60/758,470, filed on Jan. 12, 2006, which is hereby incorporated herein by reference in its entirety.

### FIELD OF THE INVENTION

The present invention relates to a method and system for formation of a cooperative.

### BACKGROUND OF THE INVENTION

It is estimated that cooperatives employ 100 million people worldwide. Formation of a cooperative as a legal entity has certain benefits, including: (1) the board being controlled by the members of the cooperative; (2) profits from the cooperative's activities being distributed proportionately to each member's individual activity as a percentage of the total activities of the cooperative; (3) certain tax advantages being gained by cooperative activities versus individual enterprises; and (4) lower operational costs being achieved as a cooperative versus individual operations.

Unfortunately, there are several disadvantages associated with known methods of forming a cooperative that serve as strong deterrents for those considering formation of a legal entity. For example, current methods of cooperative formation generally require an extensive amount of time to complete. Another disadvantage is that few businesses select a cooperative as a legal entity because of the restricted access to financing that is inherent to cooperatives. Further, even after a stakeholder group recognizes the benefits that a cooperative can have for their individual businesses, the group must have the financing or financial capacity to pay for several up-front costs associated with cooperative formation: 1) creation of committees necessary to perform an evaluation of the cooperative, 2) marketing the cooperative to potential cooperative members, and 3) the time required to realize economic returns sufficient to cover the costs associated with the initiation of the cooperative. Finally, another disadvantage is that existing methods of cooperative formation require sharing of information (for purposes of evaluating the viability of the formation) among potential cooperative members that may also be competitors, thus exposing each potential member business to competitor evaluation of the business' economic and business activities and creating a possible disincentive to initiate cooperative formation.

There is a need in the art for an improved method and system for forming a cooperative that addresses one or more of these problems.

### BRIEF SUMMARY

One embodiment relates a method of cooperative formation. The method includes forming a cooperative entity and a corporation entity and selling a percentage of the corporation entity to the cooperative entity. In addition, the method includes providing an incentive either to a prospective member or member of the cooperative entity for selling a product or service or to a purchaser for purchasing the product or service.

Another embodiment is a cooperative legal entity structure. The structure includes a corporation entity and a cooperative entity that owns a percentage of the corporation entity. In addition, the structure includes at least one cooperative member that receives an incentive for selling a product or service provided by the corporation entity.

Another implementation relates to a method of attracting private investment in a cooperative entity. The method includes forming a cooperative entity and a limited liability corporation (“LLC”), wherein the cooperative entity owns a percentage of the LLC in exchange for a down payment and an amount owed. Further, the method includes establishing a transfer mechanism to a prospective cooperative member entity. The transfer mechanism can be any one or more of co-marketing fees, returns from operations, and potential stock appreciation. The transfer mechanism incentivizes the prospective member entity to participate in the cooperative entity and to market a product or service of the LLC to associates, customers, owners or members of the prospective member entity.

A further embodiment relates to a method of attracting private investment in a new cooperative entity. The method includes forming a new corporation entity and forming a new cooperative entity to market the product or service provided by the new corporation entity. The cooperative entity owns shares in the new corporation entity. The method further includes selling the product or service to at least one member of the new cooperative entity at a fair market value and providing an incentive to the at least one member of the new cooperative entity for the sale.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a schematic view of a system for the formation of a cooperative entity, according to one embodiment.

FIG. 2 is a flow diagram of a marketing process for a method of cooperative formation, according to one embodiment.

### DETAILED DESCRIPTION

The present invention relates to an improved system and method for forming a cooperative. That is, certain implementations of the methods and systems set forth in this application provide a fast and efficient cooperative formation process that eliminates many of the formation restraints inherent to known cooperative formation methods and thus makes the concept of a cooperative legal entity far more attractive and feasible for anyone considering formation of a business entity while also allowing greater financial benefits to pass through to individual cooperative members in comparison to known formation methods.

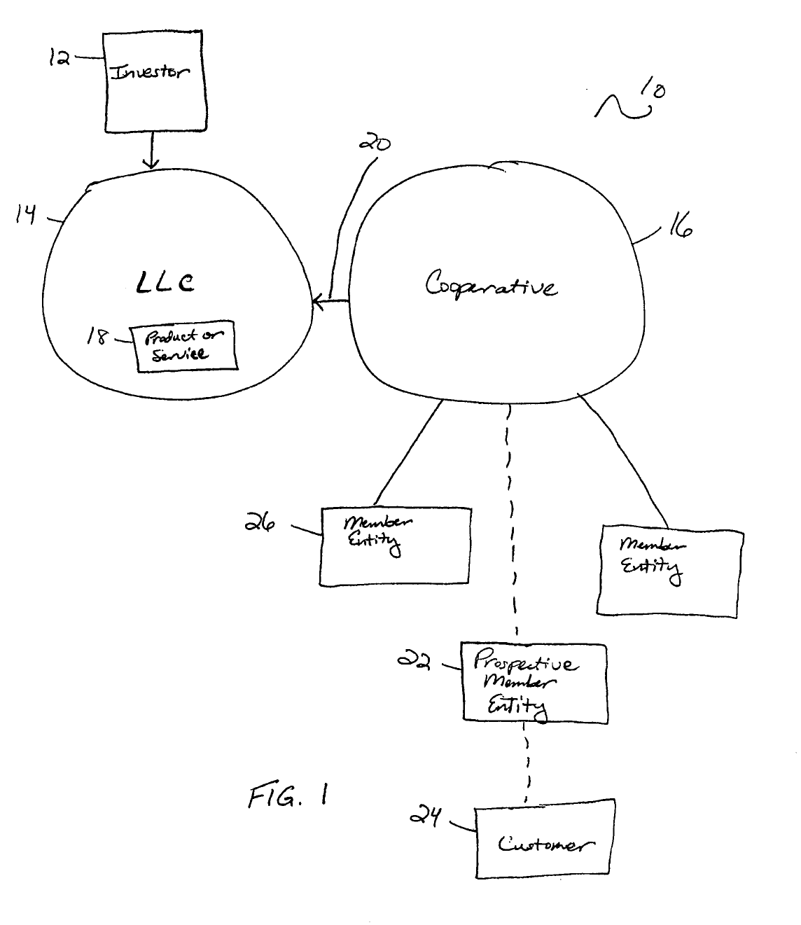

In one embodiment as set forth in the structural schematic of FIG. 1, the method 10 includes an initial investor 12 forming a limited liability corporation (“LLC”) 14 and a cooperative 16, wherein the LLC 14 provides at least one product or service 18. Alternatively, the corporation can be a C corporation, an S corporation, or any other type of legal entity other than a cooperative. According to one embodiment, the cooperative 16 and LLC 14 are formed at substantially the same time. Alternatively, the cooperative 16 and LLC 14 are formed at different times. In one embodiment, after formation of both entities, some portion of the LLC 14 is sold to the cooperative 16 (wherein the sale is represented by arrow 20). In an alternative embodiment, the method also includes providing an incentive to a member entity 26 or a prospective member entity 22 for the sale of at least one or both of a product or service 18 or an incentive to a customer 24 for the purchase of the product or service 18. This incentive allows the member entity 26 or prospective member entity 22 to market or sell the product or service 18 to the customer 24 at some discount. In one implementation, certain methods and systems described herein allow for cooperative formation more quickly than any other known formation process.

As discussed above, the cooperative 16 acquires (arrow 20) some percentage ownership of the LLC 14. According to one embodiment, the cooperative 16 acquires any percentage ownership of the LLC 14, even a majority percentage, so long as the LLC 14 retains some authority over the cooperative 16 board nomination process. That is, according to this embodiment, either the LLC 14, the initial investor 12, some other major shareholder of the LLC 14, one or more members of the LLC 14 board of directors, or some combination thereof has some control over or input into the nomination process for the cooperative 16 board of directors. According to one implementation, the cooperative 16 acquires a percentage ranging from about 1% to about 51%. Keep in mind that the percentage can be greater than 51% so long as the LLC 14 retains some level of cooperative 16 board nomination authority, perhaps through some agreement, bylaw, or any other known mechanism. Alternatively, the cooperative 16 acquires a percentage ranging from about 5% to about 40%. In a further alternative, the cooperative 16 acquires a percentage ranging from about 10% to about 35%. In yet another alternative, the cooperative 16 acquires any percentage that allows the cooperative 16 to provide a sufficient return to the cooperative member entities 26 so as to attract member interest in investing in the cooperative 16.

According to one embodiment, the amount of money provided by the cooperative 16 in exchange for the percentage of the LLC 14 is any amount that provides a sufficient return to the LLC 14 shareholders. The cooperative's 16 acquisition of a portion of the LLC 14 creates a note for the cooperative 16 and a receivable for the LLC 14. Thus, according to one embodiment, the receivable is equivalent to cash for the LLC 14, thereby allowing the LLC 14 to cover expenses with the receivable until profits from the operation of the overall enterprise (LLC 14 and cooperative 16) reach a level to cover such expenses. In accordance with one implementation, the LLC 14 (or the initial investor 12, some other major shareholder of the LLC 14, one or more members of the LLC 14 board of directors, or some combination thereof) also receives, in exchange for the note, preferred shareholder rights. In one aspect, the preferred shareholder rights include some control or authority over the cooperative 16 board nomination process.

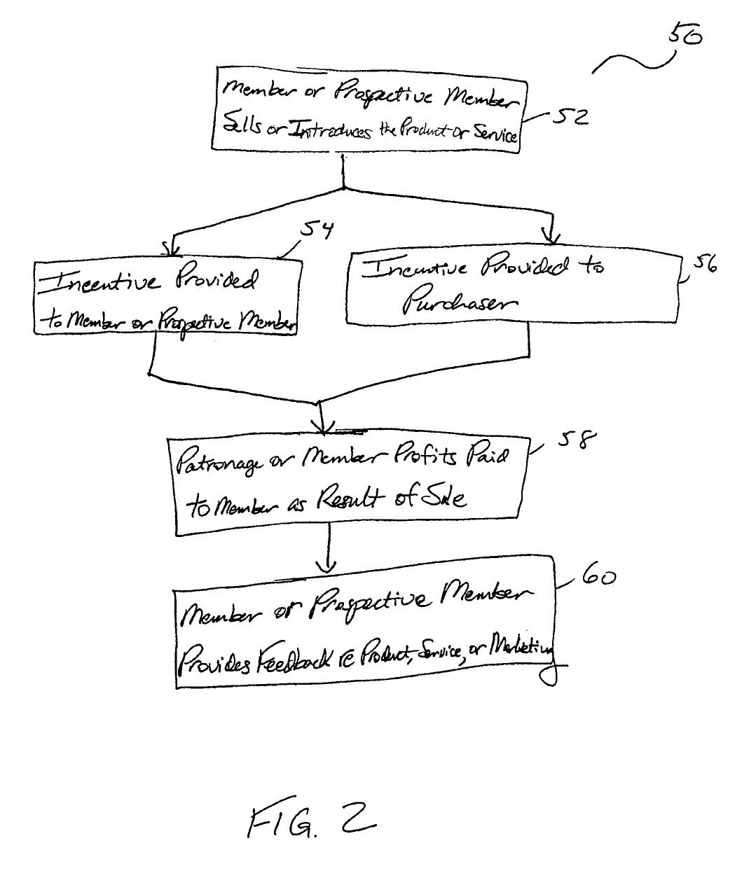

In one alternative implementation, the method can include a marketing component or process that further speeds cooperative formation while providing incentives for prospective members 22 to become members 26 of the cooperative 16. One embodiment of the marketing process 50 is depicted in FIG. 2. In this embodiment, the marketing component 50 includes the member 26 or prospective member 22 selling or introducing the product or service to a customer 24 (block 52). As a result of the sale or introduction, an incentive is provided to either the member 26 or prospective member 22 who sold the product or service (block 54) or to the purchaser of the product or service (block 56). In an alternative embodiment, an additional incentive to member entities 26 is the financial benefit of any cooperative profits in the form of a patronage payment or other form of shared profits payment that results from the sale of the product or service (block 58). In a further alternative, the member entity 26 or prospective member entity 22 provides feedback to the cooperative 16 and/or the LLC 14 regarding the product or service or marketing related to the product or service.

The incentive provided to the member 26 or prospective member 22 (block 54) or to the purchaser (block 56) allows the prospective member entity 22 or member entity 26 to market or sell the product or service 18 to the customer 24 at some discount. According to one embodiment, the intention of the incentive in either case is to create an incentive for the customer to purchase the product or service. In other words, according to this particular embodiment, a prospective member entity 22 will be provided the opportunity to initially introduce the product or service to a customer 24 at some discount in cost to both the entity 22 and the customer 24, thereby providing a cost savings to both the prospective member 22 and the customer 24, thereby incentivizing the member 26 or prospective member 22 to market the product or service 18 and further incentivizing the customer 24 to purchase it.

In one embodiment, the customer 24 is a third party customer 24. Alternatively, the customer 24 is a member or user of the member entity 26 or prospective member entity 22.

According to one embodiment, the incentive is a fee, a stock option, a discount, or any other known incentive or method of creating an incentive for a prospective member 22 entity to market and/or sell the product or service to a customer 24 and/or for the customer 24 to purchase the product or service.

It is understood that any reference herein to a “product or service” encompasses at least one or both of a product or service, or some combination of more than one product and more than one service.

In an alternative embodiment as mentioned above with respect to FIG. 2, a method of forming a cooperative with a marketing component provides for additional financial benefits, in addition to the incentive, to the member entity 26 in the form of cooperative profits (block 58), thereby providing further incentive for selling the product or service 18 and thus increasing profits to the cooperative 16 and LLC 14 (and providing further incentive for a prospective member 22 to become a member 26). That is, in the event that any sale or sales result in increased profits for the cooperative 16, such sale or sales translate into increased profits for each member entity 26. In one embodiment, those increased profits are distributed in the form of patronage payments or any other form of profit distribution (block 58). It is understood, of course, that such profits are typically not distributed based on each individual sale but rather based on profits (based on sales) over some predetermined period of time. Alternatively, it is possible that a specific sale does not result in increased profits and thus such specific sale does not result in an increased financial gain for the member entity 26.

In another alternative, one method provides for additional financial benefits for the cooperative 16 and thus cooperative members 26 in the form of increased LLC stock value. That is, the sale of products or services 18 results in increased profits not only for the cooperative 16, but also the LLC 14. As profits increase for the LLC 14, the value of any stock or other types of ownership in the LLC 14 increases, including the shares of the LLC owned by the cooperative 16. As the cooperative's 16 investment in the LLC 14 increases in value, the value of each cooperative member's 26 share in the cooperative 16 increases in value, thereby resulting in further increased financial benefits to each member 26, thereby enhancing the desirability of joining the cooperative 16. Further, as each new member 26 joins the cooperative 16, the new member 26 represents additional revenues for the LLC 14, thereby further increasing the profits and therefore the value of the LLC 14 such that the increased profits and increase in value multiply.

In yet another alternative implementation, the marketing process includes a feedback component (block 60) as discussed briefly above. This embodiment provides for feedback from the member entity 26 or prospective member entity 22 to the LLC 14 and/or the cooperative 16. That is, as the prospective member entity 22 or member entity 26 markets and sells the product or service, such prospective member 22 or member 26 is in a position to evaluate various characteristics of the product or service and the marketing thereof. In addition, the prospective member 22 or member 26 is also well-positioned to receive evaluative feedback from its customers, employees, principals, or other individuals associated with the prospective member 22 or member 26. Thus, the prospective member 22 or member 26 then provides this feedback to the cooperative 16 or LLC 14, thereby providing a mechanism for improvement of the product or service 18 or the marketing of the same. On the other hand, it is understood that no feedback component is required.

In accordance with one implementation of a method and system for forming a cooperative, the marketing component 50 provides dual benefits relating to a prospective member entity 22. First, it allows the prospective member 22 (or one or more decision-makers within that entity) to evaluate the product or service as to quality, performance, marketability, or other such characteristics, especially in embodiments in which the product or service is simply introduced to the customer 24. Second, it also allows the prospective member 22 (or one or more decision-makers within that entity) concurrently to evaluate the desirability/viability of becoming a member entity 26 of the cooperative 16. This allows the prospective member 22 to assess such viability considerations as whether the cooperative 16 will provide satisfactory returns on investment. That is, the entity 22, by participating in this marketing component, can examine the marketing success and quality of the product or service while concurrently examining the operational impact (such as profits vs. risks, for example) of participating in the system or structure of this embodiment. As such, it is likely that the system and method of this embodiment with the marketing component addresses, and likely lowers or eliminates, the perceived barriers or reluctance that may otherwise exist for a prospective member entity 22 by providing the prospective member with a “test run” of sorts that gives the prospective member 22 important information it would not otherwise have without participating in the marketing component.

In one particular embodiment, the marketing component 50 creates an incentive for the CEO, President, or other authorized decision-maker of a prospective member 22 to overcome the inherent internal barriers to joining the cooperative 16. That is, the prospective member entity 22 may have certain complex procedures or processes typically utilized prior to making a determination such as becoming a member of a cooperative. Further, various individuals within the prospective member entity 22 may resist such a determination. The marketing component 50 according to this embodiment allows the prospective member 22 decision-maker to evaluate the product or service 18 and the cooperative structure without having to go through any of the complex procedures or processes and/or such that the decision-maker and others within the prospective member entity 22 can learn about the product or service and the cooperative structure without having to first become a member.

According to another embodiment, an additional benefit of the marketing component is that the use of a prospective member entity 22 or member entity 26 to introduce, market, and/or sell the product or service 18—wherein the prospective member 22 or member 26 already has credibility and existing relationships with its customers—increases the likelihood that such customers will purchase the product or service and make full payment for the purchase. These existing relationships between entities and customers result in a type of inherent “pre-screening” process in which the customers 24 approached by the prospective member 22 or member 26 are likely customers 24 that are known to the member 22 or 26 to be (1) likely to purchase the product, and/or (2) capable of paying for the product. Thus, the marketing component according to one embodiment can increase sales and reduce or minimize receivable problems, thereby increasing the competitive advantage over other business models of certain embodiments of the cooperative structure and marketing component.

Although the present invention has been described with reference to preferred embodiments, persons skilled in the art will recognize that changes may be made in form and detail without departing from the spirit and scope of the invention.

### EXAMPLE

One formation according to certain embodiments set forth herein was completed in the area of agricultural labor in the United States.

Basic Components of Cooperative and LLC

In this example, the initial investors were providers of H2A visa labor for farmers. The cooperative and LLC were initiated on the same day. The investors contributed an initial investment of $1,550,000 into the LLC, including $50,000 in cash and $1,500,000 in kind. The cooperative paid $300,000 for 20% ownership of the LLC, and 2,000 shares were authorized in the cooperative at a price of $1,500 per share (with 10% down and the balance paid over three years).

Marketing Component

Membership was solicited by the LLC management after formation. The CEO or President of each organization which the LLC Management approached introduced the LLC's labor services to their respective organization's members, who then determined individually whether or not to utilize the LLC service. Of the approximately 2,800 members shown the service, 2,800 members were introduced to the LLC's labor services via their organization's monthly newsletter and 50 members were introduced to the services in face-to-face meetings with the LLC management. Of this total, 10 farmers tried the labor services of the LLC. Of those 10, 9 clients had participated in the face-to-face meetings (in which the organization's CEO was present and introduced the LLC management), while 1 client signed up after reading about LLC's labor services in the member monthly newsletter (with no face to face meeting). The total advertising and marketing costs incurred by the LLC during this process was $2,610.

Resulting Membership and Structure of Cooperative

After completion of the marketing component, the cooperative had the following membership:
1. California Trade Association
2. Egg Producer
3. National Branded Vegetable Supplier Cooperative—the cooperative was considering membership, and the CEO introduced the LLC's labor services to the cooperative members for a co-marketing fee
4. Pork Producer State Organization—introduced the LLC's labor services to its membership for a co-marketing fee

In addition, the cooperative had the following three board of directors after completion of the marketing component:
1. Executive Director of the California Trade Association
2. Two Directors from the LLC

After the formation of the cooperative, ten farms used the LLC's labor services during the first six months of operation, using about 250 H2A visa workers in Florida, California, Utah, Colorado, and New Mexico. All farmers placed through the LLC paid all amounts owed for the labor services.

As a point of comparison, during the same period, the same provider of H2A workers ran concurrently a non-cooperative farm labor operation that was not formed according to any of the embodiments of cooperative formation described herein. The operation provided the same service that was provided by the LLC. The operation placed a total of 70 new workers at only 1 farm during that time. In addition, it should be noted that the farmer did not pay the provider and is now being sued by the provider for collection. It should also be noted that the provider spent at least $24,000 on marketing and advertising for the services.

Financial Results of Cooperative Formed According to Certain Aspects of Embodiments Herein

Revenues for the first six months totalled $51,250 (vs. projected revenues of $51,500). The amount of co-marketing payments made to the member organizations was $1,335 of the total marketing expense of $2,610. Further, the return on investment (excluding any patronage payments for cooperative members) for the members was as follows. The California Trade Association paid $150 for 1 share (10% of the $1,500/share price) and received a co-marketing payment of $1,215. In addition, the Vegetable Coop received a $120 co-marketing payment for introduction of the LLC's services.

What is claimed is:

1. A method of cooperative formation, the method comprising:
forming a cooperative entity and a corporation entity, wherein the corporation entity provides a product or service;
selling a percentage of the corporation entity to the cooperative entity, whereby the cooperative entity holds stock in the corporation entity; and
providing an incentive either to a prospective member or member of the cooperative entity for introducing, marketing, or selling the product or service or to a purchaser for testing or purchasing the product or service.

2. The method of claim 1, wherein the incentive is a discount.

3. The method of claim 1, wherein the incentive is a bonus.

4. The method of claim 1, further comprising distributing cooperative profits to the member of the cooperative entity based on the sale of the product or service.

5. The method of claim 4, wherein distributing cooperative profits comprises providing a patronage payment to the member of the cooperative entity.

6. The method of claim 1, wherein resulting sales of the product or service results in profits that result in an increase in the value of the stock in the corporation entity, whereby the stock held by the cooperative entity increases, whereby each member of the cooperative entity benefits.

7. The method of claim 1, wherein the corporation entity is a limited liability corporation (“LLC”).

8. A cooperative legal entity structure comprising:
(a) a corporation entity, wherein the corporation entity provides a product or service;
(b) a cooperative entity, wherein the cooperative entity owns a percentage of the corporation entity; and
(c) at least one cooperative member, wherein the cooperative member receives an incentive for introducing, marketing, or selling the product or service.

9. The structure of claim 8, wherein the incentive is chosen from any one or more of the group consisting of a discount or a bonus.

10. The structure of claim 8, wherein the cooperative member receives a patronage payment based on profits resulting from selling the product or service.

11. The structure of claim 8, wherein the value of the cooperative member's shares in the cooperative entity increase as a result of an increase in the value of the cooperative entity's percentage ownership in the corporation entity based on the corporation entity's profits resulting from selling the product or service.

12. The structure of claim 8, wherein the corporation entity is a limited liability corporation (“LLC”).

13. A method of attracting private investment in a cooperative entity, the method comprising:
forming a cooperative entity and a limited liability corporation (“LLC”), wherein the cooperative entity owns a percentage of the LLC in exchange for a down payment and an amount owed;
establishing a transfer mechanism comprising at least one of co-marketing fees, returns from operations, and potential stock appreciation to a prospective cooperative member entity, whereby the prospective member entity is incentivized to participate in the cooperative entity and to market a product or service of the LLC to associates, customers, owners or members of the prospective member entity.

14. The method of claim 13, wherein the transfer mechanism lowers any perceived risk associated with participating in the cooperative entity.

15. The structure of claim 14, whereby membership in the cooperative entity increases.

16. The structure of claim 13, whereby capital inflow into the cooperative entity allows for payment of the amount owed to the LLC.

17. The structure of claim 16, whereby an investor in the LLC receives a return on investment for the inventor's initial investment in the LLC.

18. A method of attracting private investment in a new cooperative entity, the method comprising:
forming a new corporation entity, wherein the corporation entity provides a product or service;
forming a new cooperative entity to market the product or service, wherein the cooperative entity owns shares in the new corporation entity;
introducing, marketing, or selling at a fair market value the product or service to at least one member of the new cooperative entity, providing an incentive to the at least one member of the new cooperative entity for the introduction, marketing, or sale.

19. The method of claim 18, wherein the incentive is a discount.

20. The method of claim 18, further comprising providing a patronage payment to the at least one member of the new cooperative entity based on the sale.

21. The method of claim 18, wherein the selling the product or service results in increased profits for the new cooperative entity, whereby the at least one member's shares in the new cooperative entity increase in value.

22. The method of claim 18, wherein the selling the product or service results in increased profits for the corporation entity, whereby the new cooperative entity's shares increase in value.
